(19) United States
(12) Patent Application Publication
(10) Pub. No.: US 2025/0040530 A1
(43) Pub. Date: Feb. 6, 2025

(54) Live Bait Storage Device

(71) Applicants: Blaine Hays, Jesup, GA (US); Cal Hays, Macon, GA (US)

(72) Inventors: Blaine Hays, Jesup, GA (US); Cal Hays, Macon, GA (US)

(21) Appl. No.: 18/775,031

(22) Filed: Jul. 17, 2024

Related U.S. Application Data
(60) Provisional application No. 63/516,942, filed on Aug. 1, 2023.

(51) Int. Cl. A01K 97/05

(52) U.S. Cl. CPC A01K 97/05

(57) ABSTRACT

A live bait storage device is disclosed that keeps fishing bait alive and well for prolonged periods of time. The live bait storage device comprises a body component that is configured to store a plurality of live bait and is made from sturdy materials to prevent leaks or damage. The body component comprises an integrated aerator component that will keep the live bait healthy for fishing. The integrated aerator component comprises an aerator, air stone, hose, and battery pack that are built-in to eliminate the need for external components. The integrated aerator component is powered by rechargeable or replaceable batteries. The batteries are protected inside a waterproof storage mechanism to help prevent corrosion. Thus, users can keep their live bait safe, healthy, and easily accessible.

### CROSS-REFERENCE TO RELATED APPLICATION

The present application claims priority to, and the benefit of, U.S. Provisional Application No. 63/516,942, which was filed on Aug. 1, 2023, and is incorporated herein by reference in its entirety.

### FIELD OF THE INVENTION

The present invention relates generally to the field of live bait storage devices. More specifically, the present invention relates to an all-in-one live well for storing live bait when fishing on a boat, on the shore, ice fishing, etc. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in live bait storage devices. Generally, standard live wells for live bait may not be effective enough at storing the bait. People may opt to store live bait in a five-gallon bucket which can lead to leaks. Further, live wells may have batteries placed in areas that are susceptible to water leaks, ultimately causing corrosion. Additionally, an aerator box and hose can be frustrating to use.

Typical live bait buckets do not include aeration devices, thus unless the water in these buckets is changed as the oxygen content drops, the live bait will not survive. Further, separate or detachable aeration devices have been provided for use with such buckets, however, these devices are not only cumbersome at times to use but are also relatively expensive since they include a separate housing, and usually means for attachment to the live bait bucket. Further, means may not be provided for assuring the disbursement of the air into the water at the bottom of the bucket, which is believed to be the most efficient disbursement location.

Accordingly, there is a demand for an improved live bait storage device that provides a means for storing live bait which includes an integrated aerator that can operate without an external hose. More particularly, there is a demand for a live bait storage device that keeps fishing bait alive for prolonged periods of time.

Therefore, there exists a long-felt need in the art for a live bait storage device that provides users with an all-in-one live well for storing live bait when fishing on a boat, on the shore, ice fishing, etc. There is also a long-felt need in the art for a live bait storage device that features a specialized integrated aerator that can operate without an external hose that will keep the live bait healthy. Further, there is a long-felt need in the art for a live bait storage device that allows users to easily access the bait via a quick access hatch on the lid. Moreover, there is a long-felt need in the art for a device that eliminates the need for any external components to maintain optimal function and to keep the live bait alive and healthy. Further, there is a long-felt need in the art for a live bait storage device that utilizes a waterproof storage device for the batteries to prevent leaks, damage, and corrosion. Finally, there is a long-felt need in the art for a live bait storage device that can be used for aquariums and exotic fish stores for transporting expensive, exotic fish.

The subject matter disclosed and claimed herein, in one embodiment thereof, comprises a live bait storage device. The device will keep fishing bait alive and well for prolonged periods of time. The live bait storage device comprises a body component that is configured to store a plurality of live bait and is made from sturdy materials to prevent leaks or damage. The body component comprises an integrated aerator component that will keep the live bait healthy for fishing. The integrated aerator component comprises an aerator, air stone, hose, and battery pack that are built-in to eliminate the need for external components. The integrated aerator component is powered by rechargeable or replaceable batteries. The batteries are protected inside a waterproof storage mechanism to help prevent corrosion. Thus, users can keep their live bait safe, healthy, and easily accessible.

In this manner, the live bait storage device of the present invention accomplishes all of the foregoing objectives and provides users with a device that provides a means for storing live bait. The device is a live bait storage device with an integrated aerator component. The device can be manufactured of sturdy materials to prevent leaks or damage.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a live bait storage device. The device will keep fishing bait alive and well for prolonged periods of time. The live bait storage device comprises a body component that is configured to store a plurality of live bait and is made from sturdy materials to prevent leaks or damage. The body component comprises an integrated aerator component that will keep the live bait healthy for fishing. Thus, users can keep their live bait safe, healthy, and easily accessible.

In one embodiment, the live bait storage device, in use, is filled with water to a desired level, sufficient to keep the bait alive and in good health for as long as the water is adequately aerated. An integrated aerator component powered by a battery is integrated into the device so as to bubble air under pressure through the water and aerate the live bait.

In one embodiment, the live bait storage device comprises a body component that is a “standard” tapered five-gallon (18.9 liters) bucket or is shaped like a standard bucket, with a bottom side, an open top side, and a cylindrical sidewall creating an interior cavity which can be filled with water and live bait. Further, the body component is preferably provided with a handle for easy portability and a substantially rigid lid with a quick access hatch integrated into the lid. Such tapered five-gallon buckets have an inner diameter near the base (at the bottom) of about 10.25 ins. (26.0 cm) and an inner diameter near the top of about 11.25 ins. (28.57 cm) and are readily available commercially. However, smaller or larger buckets may be used, if desired. The body component and lid may be manufactured of metal or a synthetic resinous material (“plastic”) but is preferably of high-density polyethylene (HDPE) or some other readily available thermoformable synthetic resinous material which is not susceptible to corrosion and can be readily cleaned so as to provide an environment in which the bait will happily survive, and which prevents leaks or damage.

In one embodiment, the lid is preferably provided with a central access opening with a quick access hatch integrated into the lid, and wherein the central access opening has a diameter in the range from about 4 ins (10.16 cm) to 7 ins (17.78 cm) to allow a person to thrust his/her hand into the otherwise closed bucket. The central access opening is closed with the quick access hatch pivotally connected to the lid by a hinge, which has a bias such that the weight of the open hatch is sufficient to urge the hatch into the closed position.

If the bait is to live and be used over an extended period of time, or even several hours, and is to remain healthy, the bait bucket is additionally provided with an integrated aerator component to aerate the water placed in the body component. For example, the integrated aerator component is used in the live bait storage device to provide air needed to maintain the bait, fish, or other aquatic life in live condition. The aerator component comprises in combination (i) a battery to power the motor; (ii) a pump; (iii) hose; and (iv) air stone, which is immersed in water in the bucket to aerate the bait within the bucket. The aerator component is built-in to the body component to eliminate the need for external components, allowing the body component to be easily transportable. Specifically, the pump is positioned on an outside of the body component in communication with the motor and the battery. The hose and attached air stone are positioned within the body component with the air stone being positioned at the bottom of the body component and the hose being run up the interior side of the body component and in communication with the pump.

Specifically, the hose with an air stone attached is connected by conventional means to a pump, or other air distributor, which distributes air through the connector to the hose and then out the air stone. The air stone is porous with different sized pores to produce tiny bubbles. When used as a bait bucket aerator, the porous air stone and attached hose are immersed in water containing live bait, and air is pumped through the hose and out the air stone to produce tiny air bubbles which emerge from the air stone and pass into the water to maintain the bait in a live condition. The pump is energized by a battery and a multitude of small air bubbles emerge from the porous air stone and pass into the water. This arrangement is extremely convenient and produces a highly efficient bait bucket which is easily transported.

In one embodiment, the air pump is driven by an electric motor which is powered by batteries. The batteries can be rechargeable and/or replaceable. The batteries are housed within a battery case which includes a switch which controls the supply of electrical energy from the battery to the electric motor. The battery case is waterproof to prevent corrosion.

In another embodiment, taking into consideration that the amount of air necessary to maintain the oxygen level in the water may vary depending upon the type and number of live bait bodies therein, the motor could be provided with two windings, to permit two speeds of operation. Two speed operation of the motor could also be provided by replacing the single battery, with two or more batteries.

In one embodiment, the body component comprises a perforated or porous bowl-shaped container, referred to herein as a colander, which is removably, slidably inserted into the body component. By “bowl-shaped” it is meant that the colander is approximately concavo-convex. Further, the colander may be made of a non-corroding metal such as aluminum or copper, but for economy, is preferably of a synthetic resinous material, typically polyethylene, and relatively thin, preferably in the range from about 10 mils (254 μm) to 50 mils (1270 μm) thick, to save on weight and material, yet adequately support the weight of the bait to be kept in the body component. Further, the colander is preferably bowl-shaped, having a depth in the range from about 2″ (5.08 cm) to 6″ (15.24 cm) is provided with perforations small enough, that is, less than 0.25″ wide, so as to preclude a bait from passing through one of the perforations.

In one embodiment, the live bait storage device comprises a drain through which used or stale water can be drained out of the body component either before it is replenished, or while it is being replenished with water, whether the water is salt water, brackish water or fresh water, and whether the body component is to be drained on land, or in a boat on the water. Moreover, it is desirable that the drain be opened and closed, with one hand, conveniently, even when the device is being drained in a moving boat. In one embodiment, the drain includes an on/off rotary or ball valve, etc.

In one embodiment, the live bait storage device can be used as a bait bucket for aquariums and exotic fish stores, allowing users to use the device to transport expensive exotic fish or pieces of reefs for aquariums. Users can rent or just use the device to make the transport easier. Thus, the live bait storage device can be used for aquariums and exotic fish stores for transporting expensive, exotic fish.

In yet another embodiment, the live bait storage device comprises a plurality of indicia.

In yet another embodiment, a method of storing live bait when fishing is disclosed. The method includes the steps of providing a live bait storage device comprising a body component and lid with an integrated aerator component powered by batteries. The method also comprises filling the body component with water. Further, the method comprises inserting a plurality of bait into the water. The method also comprises turning on the integrated aerator component to keep the bait alive and well for a prolonged period of time. Finally, the method comprises fishing with the live bait storage device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a cross-sectional view of one embodiment of the live bait storage device of the present invention in accordance with the disclosed architecture;

FIG. 2 illustrates a cross-sectional view of one embodiment of the live bait storage device of the present invention showing the body component in accordance with the disclosed architecture;

FIG. 3 illustrates a cross-sectional view of one embodiment of the live bait storage device of the present invention showing how the body component holds live bait in accordance with the disclosed architecture;

FIG. 4 illustrates a perspective view of one embodiment of the live bait storage device of the present invention showing the rechargeable and replaceable batteries in accordance with the disclosed architecture;

FIG. 5 illustrates a perspective view of one embodiment of the live bait storage device of the present invention showing the quick access hatch integrated into the lid in accordance with the disclosed architecture; and

FIG. 6 illustrates a flowchart showing the method of storing live bait when fishing in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a live bait storage device that provides users with an all-in-one live well for storing live bait when fishing on a boat, on the shore, ice fishing, etc. There is also a long-felt need in the art for a live bait storage device that features a specialized integrated aerator that can operate without an external hose that will keep the live bait healthy. Further, there is a long-felt need in the art for a live bait storage device that allows users to easily access the bait via a quick access hatch on the lid. Moreover, there is a long-felt need in the art for a device that eliminates the need for any external components to maintain optimal function and to keep the live bait alive and healthy. Further, there is a long-felt need in the art for a live bait storage device that utilizes a waterproof storage device for the batteries to prevent leaks, damage, and corrosion. Finally, there is a long-felt need in the art for a live bait storage device that can be used for aquariums and exotic fish stores for transporting expensive, exotic fish.

The present invention, in one exemplary embodiment, is a novel live bait storage device. The device will keep fishing bait alive and well for prolonged periods of time. The live bait storage device comprises a body component with a lid that is configured to store a plurality of live bait and is made from sturdy materials to prevent leaks or damage. The body component comprises an integrated aerator component that will keep the live bait healthy for fishing. The integrated aerator component comprises an aerator, air stone, hose, and battery pack that are built-in to eliminate the need for external components. The integrated aerator component is powered by rechargeable or replaceable batteries. The batteries are protected inside a waterproof storage mechanism to help prevent corrosion. Thus, users can keep their live bait safe, healthy, and easily accessible. The present invention also includes a novel method of storing live bait when fishing. The method includes the steps of providing a live bait storage device comprising a body component and lid with an integrated aerator component powered by batteries. The method also comprises filling the body component with water. Further, the method comprises inserting a plurality of bait into the water. The method also comprises turning on the integrated aerator component to keep the bait alive and well for a prolonged period of time. Finally, the method comprises fishing with the live bait storage device.

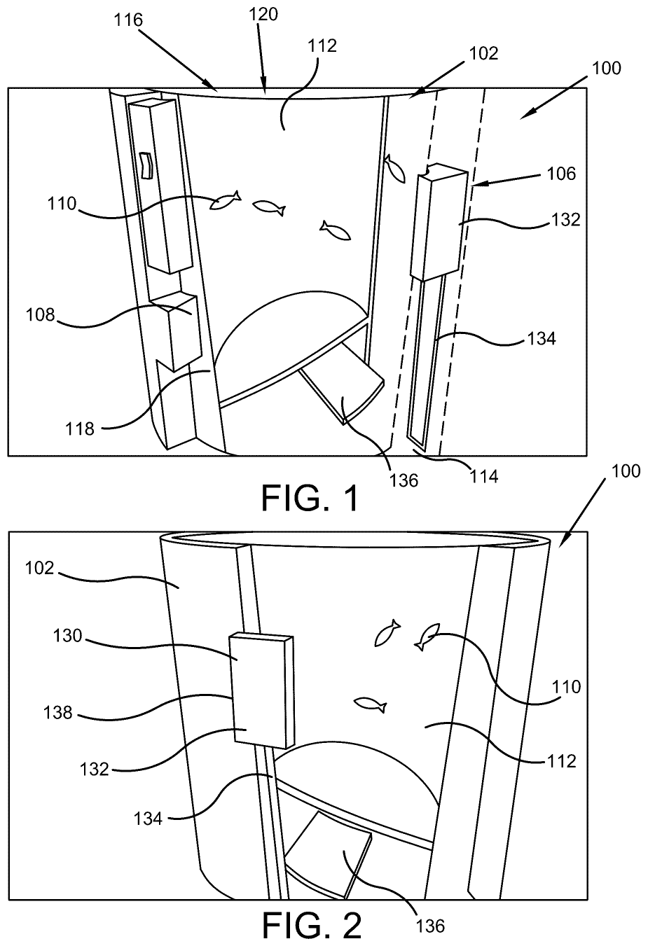

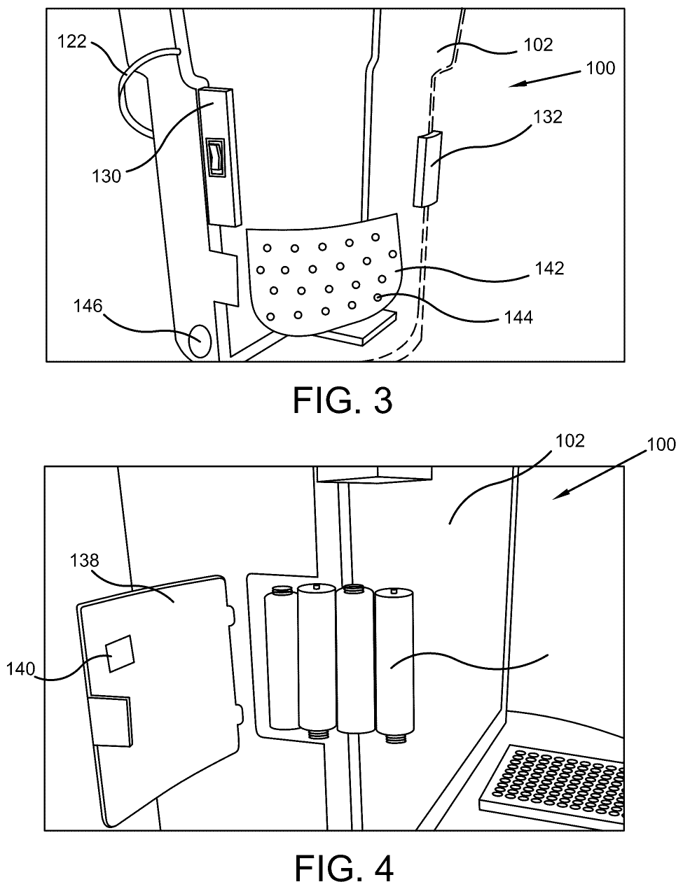

Referring initially to the drawings, FIGS. 1-3 illustrate a perspective view of one embodiment of the live bait storage device 100 of the present invention. In the present embodiment, the live bait storage device 100 is an improved live bait storage device 100 that provides a user with an all-in-one live well for storing live bait when fishing on a boat, on the shore, ice fishing, etc. The device 100 will keep fishing bait alive and well for prolonged periods of time. Specifically, the live boat storage device 100 comprises a body component 102 and a lid 104 with an integrated aerator component 106 powered by batteries 108. Thus, users can keep their live bait 110 safe, healthy, and easily accessible.

Generally, the live bait storage device 100, in use, is filled with water 112 to a desired level, sufficient to keep the bait 110 alive and in good health for as long as the water 112 is adequately aerated. An integrated aerator component 106 powered by a battery 108 is integrated into the device 100 so as to bubble air under pressure through the water 112 and aerate the live bait 110.

Furthermore, the live bait storage device 100 comprises a body component 102 that is a “standard” tapered five-gallon (18.9 liters) bucket or is shaped like a standard bucket, with a bottom side 114, an open top side 116, and a cylindrical sidewall 118 creating an interior cavity 120 which can be filled with water 112 and live bait 110. Further, the body component 102 is preferably provided with a handle 122 for easy portability and a substantially rigid lid 104 with a quick access hatch 124 integrated into the lid 104. Such conventional tapered five-gallon buckets have an inner diameter near the base (at the bottom) of about 10.25 ins. (26.0 cm) and an inner diameter near the top of about 11.25 ins. (28.57 cm) and are readily available commercially. However, smaller or larger buckets may be used, if desired. The body component 102 and lid 104 may be manufactured of metal or a synthetic resinous material (“plastic”) but is preferably of high-density polyethylene (HDPE) or some other readily available thermoformable synthetic resinous material which is not susceptible to corrosion and can be readily cleaned so as to provide an environment in which the bait 110 will happily survive, and which prevents leaks or damage.

Additionally, the lid 104 is preferably provided with a central access opening 126 with a quick access hatch 124 integrated into the lid 104, and wherein the central access opening 126 has a diameter in the range from about 4 ins (10.16 cm) to 7 ins (17.78 cm) to allow a person to thrust his/her hand into the otherwise closed body component 102. The central access opening 126 is closed with the quick access hatch 124 pivotally connected to the lid 104 by a hinge 128, which has a bias such that the weight of the open hatch 124 is sufficient to urge the hatch 124 into the closed position.

If the bait 110 is to live and be used over an extended period of time, or even several hours, and is to remain healthy, the device 100 is additionally provided with an integrated aerator component 106 to aerate the water 112 placed in the body component 102. For example, the integrated aerator component 106 is used in the live bait storage device 100 to provide air needed to maintain the bait 110, fish, or other aquatic life in live condition. The aerator component 106 comprises in combination (i) a battery 108 to power the motor 130; (ii) a pump 132; (iii) hose 134; and (iv) air stone 136, which is immersed in water 112 in the body component 102 to aerate the bait 110 within the body component 102. The aerator component 106 is built into the body component 102 to eliminate the need for external components, allowing the body component 102 to be easily transportable. Specifically, the pump 132 is positioned on an outside of the body component 102 in communication with the motor 130 and the battery 108. The hose 134 and attached air stone 136 are positioned within the body component 102 with the air stone 136 being positioned at the bottom of the body component 102 and the hose 134 being run up the interior side of the body component 102 and in communication with the pump 132.

Specifically, the hose 134 with an air stone 136 attached is connected by conventional means to a pump 132, or other air distributor, which distributes air through the connector to the hose 134 and then out the air stone 136. The air stone 136 is porous with different sized pores to produce tiny bubbles. When used as a bait bucket aerator, the porous air stone 136 and attached hose 134 are immersed in water 112 containing live bait 110, and the air is pumped through the hose 134 and out the air stone 136 to produce tiny air bubbles which emerge from the air stone 136 and pass into the water 112 to maintain the bait 110 in a live condition. The pump 132 is energized by a battery 108 and a multitude of small air bubbles emerge from the porous air stone and pass into the water 112. This arrangement is extremely convenient and produces a highly efficient bait bucket which is easily transported.

As shown in FIG. 4, the air pump 132 is driven by an electric motor 130 which is powered by batteries 108. The batteries 108 can be rechargeable and/or replaceable. The batteries 108 are housed within a battery case 138 which includes a switch 140 which controls the supply of electrical energy from the battery 108 to the electric motor 130. The battery case 138 is waterproof to prevent corrosion.

The battery 108 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the motor 130. Throughout this specification, the term “battery” may be used interchangeably to refer to one or more wet or dry cells or batteries of cells in which chemical energy is converted into electricity and used as a source of DC power. References to recharging or replacing the battery 108 may refer to recharging or replacing individual cells, individual batteries of cells, or a package of multiple battery cells as is appropriate for any given battery technology that may be used. In addition, a rechargeable embodiment of the battery 108 may be recharged using a USB port (not shown), wherein the USB port is a USB-A, USB-B, Micro-B, Micro-USB, Mini-USB, or USB-C port, etc.

In one embodiment, taking into consideration that the amount of air necessary to maintain the oxygen level in the water 112 may vary depending upon the type and number of live bait bodies therein, the motor 130 could be provided with two windings, to permit two speeds of operation. Two speed operation of the motor 130 could also be provided by replacing the single battery 108, with two or more batteries.

In another embodiment, the body component 102 comprises a perforated or porous bowl-shaped container, referred to herein as a colander 142, which is removably, slidably inserted into the body component 102. By “bowl-shaped” it is meant that the colander 142 is approximately concavo-convex. Further, the colander 142 may be made of a non-corroding metal such as aluminum or copper, but for economy, is preferably of a synthetic resinous material, typically polyethylene, and relatively thin, preferably in the range from about 10 mils (254 μm) to 50 mils (1270 μm) thick, to save on weight and material, yet adequately support the weight of the bait 110 to be kept in the body component 102. Further, the colander 142 is preferably bowl-shaped, having a depth in the range from about 2″ (5.08 cm) to 6″ (15.24 cm) is provided with perforations 144 small enough, that is, less than 0.25″ wide, so as to preclude a bait 110 from passing through one of the perforations 144.

In yet another embodiment, the live bait storage device 100 comprises a drain 146 through which used or stale water can be drained out of the body component 102 either before it is replenished, or while it is being replenished with water, whether the water is salt water, brackish water or fresh water, and whether the body component 102 is to be drained on land, or in a boat on the water. Moreover, it is desirable that the drain 146 be opened and closed, with one hand, conveniently, even when the device 100 is being drained in a moving boat. In one embodiment, the drain 146 includes an on/off rotary or ball valve (not shown), etc.

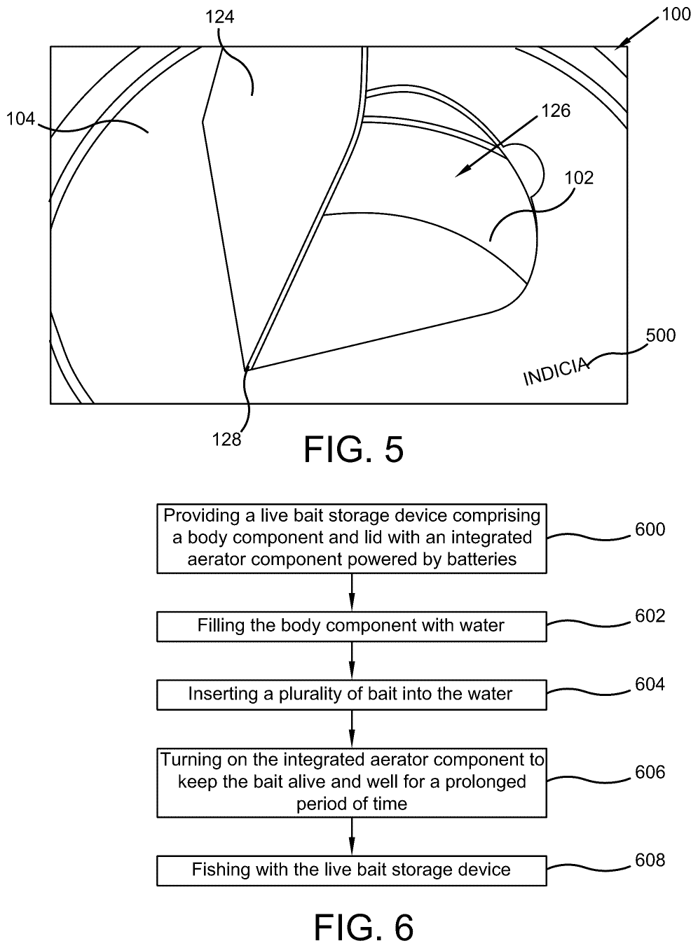

As shown in FIG. 5, the live bait storage device 100 can be used as a bait bucket for aquariums and exotic fish stores, allowing users to use the device 100 to transport expensive exotic fish or pieces of reefs for aquariums. Users can rent or just use the device 100 to make the transport easier. Thus, the live bait storage device 100 can be used for aquariums and exotic fish stores for transporting expensive, exotic fish.

In yet another embodiment, the live bait storage device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be live bait, bucket, or brand related.

FIG. 6 illustrates a flowchart of the method of storing live bait when fishing. The method includes the steps of at 600, providing a live bait storage device comprising a body component and lid with an integrated aerator component powered by batteries. The method also comprises at 602, filling the body component with water. Further, the method comprises at 604, inserting a plurality of bait into the water. The method also comprises at 606, turning on the integrated aerator component to keep the bait alive and well for a prolonged period of time. Finally, the method comprises at 608, fishing with the live bait storage device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “live bait storage device”, “live bait device”, “storage device”, and “device” are interchangeable and refer to the live bait storage device 100 of the present invention.

Notwithstanding the foregoing, the live bait storage device 100 of the present invention can be of any suitable size and configuration as is known in the art without affecting the overall concept of the invention, provided that it accomplishes the above-stated objectives. One of ordinary skill in the art will appreciate that the live bait storage device 100 as shown in FIGS. 1-6 is for illustrative purposes only, and that many other sizes and shapes of the live bait storage device 100 are well within the scope of the present disclosure. Although the dimensions of the live bait storage device 100 are important design parameters for user convenience, the live bait storage device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A live bait storage device that keeps fishing bait alive for prolonged periods of time, the live bait storage device comprising:
a body component;
a lid; and
an integrated aerator component;
wherein the body component and the lid are adapted to receive and secure a plurality of live bait and water within the body component; and
further wherein the integrated aerator component is secured within the body component allowing for transportability.

2. The live bait storage device of claim 1, wherein the body component is a standard tapered five-gallon bucket.

3. The live bait storage device of claim 1, wherein the body component is shaped like a standard bucket, with a bottom side, an open top side, and a cylindrical sidewall creating an interior cavity which can be filled with water and live bait.

4. The live bait storage device of claim 3, wherein the body component comprises a handle.

5. The live bait storage device of claim 4, wherein the lid comprises a central access opening with a quick access hatch.

6. The live bait storage device of claim 5, wherein the integrated aerator component comprises in combination a battery to power a motor; a pump; a hose; and an air stone, which is immersed in water in the body component to aerate the plurality of live bait within the body component.

7. The live bait storage device of claim 6, wherein the integrated aerator component is built-in to the body component to eliminate need for external components.

8. The live bait storage device of claim 7, wherein the pump is positioned on an outside of the body component in communication with the motor and the battery.

9. The live bait storage device of claim 8, wherein the hose and attached air stone are positioned within the body component with the air stone being positioned at a bottom of the body component and the hose being run up an interior side of the body component and in communication with the pump.

10. The live bait storage device of claim 9, wherein the hose with the air stone attached is connected by conventional means to the pump, which distributes air through a connector to the hose and then out the air stone to produce tiny bubbles.

11. The live bait storage device of claim 10, wherein the pump is energized by the battery.

12. The live bait storage device of claim 11, wherein the pump is driven by the motor which is powered by a rechargeable battery.

13. The live bait storage device of claim 12, wherein the battery is housed within a waterproof battery case with a power switch.

14. A live bait storage device that keeps fishing bait alive for prolonged periods of time, the live bait storage device comprising:
a body component that is shaped like a standard bucket, with a bottom side, an open top side, and a cylindrical sidewall creating an interior cavity which can be filled with water and live bait;
a lid; and
an integrated aerator component;
wherein the body component comprises a handle with a central access opening with a quick access hatch;
wherein the body component and the lid are adapted to receive and secure a plurality of live bait and water within the body component;
wherein the integrated aerator component comprises in combination a battery to power a motor; a pump; a hose; and an air stone, which is immersed in water in the body component to aerate the plurality of live bait within the body component;
wherein the integrated aerator component is built into the body component to eliminate need for external components;
wherein the pump is positioned on an outside of the body component in communication with the motor and the battery;
wherein the hose and attached air stone are positioned within the body component with the air stone being positioned at a bottom of the body component and the hose being run up an interior side of the body component and in communication with the pump; and
further wherein the hose with the air stone attached is connected by conventional means to the pump, which distributes air through a connector to the hose and then out the air stone to produce tiny bubbles.

15. The live bait storage device of claim 14, wherein the motor has two speeds of operation.

16. The live bait storage device of claim 14, wherein the body component comprises a perforated container, which is removably, slidably inserted into the body component to pick up bait.

17. The live bait storage device of claim 14, wherein the body component comprises a drain.

18. The live bait storage device of claim 14 further comprising a plurality of indicia.

19. The live bait storage device of claim 14, wherein the battery is rechargeable and is housed within a waterproof battery case with a power switch.

20. A method of storing live bait when fishing, the method comprising the following steps:
providing a live bait storage device comprising a body component and lid with an integrated aerator component powered by batteries;
filling the body component with water,
inserting a plurality of bait into the water,
turning on the integrated aerator component to keep the bait alive and well for a prolonged period of time; and
fishing with the live bait storage device.
